(19) United States
(12) Patent Application Publication
(10) Pub. No.: US 2026/0037742 A1
(43) Pub. Date: Feb. 5, 2026

(54) DATA ANALYSIS

(71) Applicant: Calabrio, Inc., Minneapolis, MN (US)

(72) Inventors: Alexander Kvamme, Minneapolis, MN (US); John Doig, III, Minneapolis, MN (US)

(21) Appl. No.: 19/285,802

(22) Filed: Jul. 30, 2025

Related U.S. Application Data
(60) Provisional application No. 63/677,329, filed on Jul. 30, 2024.

(51) Int. Cl. G06F 40/35; G06F 16/3329

(52) U.S. Cl. CPC G06F 40/35; G06F 16/3329

(57) ABSTRACT

Systems, devices, and methods are described for analyzing natural language conversations using task-conditioned summarization and zero-shot classification. A conversation object representing a multi-turn interaction between participants is received and optionally preprocessed to normalize structure, segment speakers, and remove filler or sensitive content. A summarization model generates semantically focused summaries aligned with analytic tasks such as sentiment detection, escalation tracking, intent classification, or resolution evaluation. Each summary is evaluated by a zero-shot classification model that compares the summary to candidate labels, either predefined or dynamically generated, using semantic similarity scoring to select one or more labels with confidence values. Outputs, including summaries, labels, and metadata, are stored in structured formats for use in analytics dashboards, automation workflows, or customer experience monitoring. The architecture supports multi-format inputs, distributed processing, and integration with enterprise systems while improving interpretability, adaptability, and real-time performance in conversation analysis applications.

### CROSS-REFERENCE TO RELATED APPLICATIONS

This application claims the benefit of priority under 35 U.S.C. § 119 (e) to U.S. provisional patent application No. 63/677,329, filed on Jul. 30, 2024, titled “data analysis method,” the entire contents of which are hereby incorporated by reference in their entirety.

### TECHNICAL FIELD

The present disclosure relates generally to the customer service analytics field, and more specifically to a new and useful method in the customer service analytics field.

### BACKGROUND

Natural language conversations—such as those exchanged during customer service interactions, technical support sessions, or digital messaging—contain valuable insights into customer sentiment, resolution outcomes, escalation dynamics, and operational gaps. These interactions, however, are often lengthy, unstructured, and contextually varied, making automated analysis both challenging and error-prone.

Conventional approaches to analyzing these conversations typically rely on manual review, keyword spotting, or fully supervised models trained for specific tasks. These solutions are often limited by their rigidity, lack of adaptability to new analytic goals, and reliance on end-to-end classification of raw transcripts. As a result, key insights are frequently missed, misclassified, or rendered too opaque for meaningful use in enterprise workflows.

### SUMMARY

The present disclosure provides a system, device, and method for analyzing natural language conversations using task-conditioned summarization and zero-shot classification of derived summaries. The disclosed architecture improves flexibility, interpretability, and scalability in extracting structured insights from unstructured human dialogue.

To this end, the system first receives a conversation object that captures a multi-turn interaction between two or more participants. This object may originate from sources such as call transcripts, chat logs, emails, or other communication platforms. The conversation object may be normalized through preprocessing, including, but not limited to, speaker turn segmentation, filler word removal, and redaction of sensitive content.

Unlike prior approaches that apply opaque classifiers directly to entire conversation transcripts, the system generates semantically focused summaries aligned with specific analytic tasks. These tasks may include sentiment analysis, escalation tracking, intent detection, resolution quality assessment, or topic categorization. Summaries are generated using prompt-conditioned inputs that allow the model to extract only the content relevant to the intended task, thereby isolating key context and improving downstream precision.

Each summary is then evaluated using a zero-shot classification model configured to select a best-fit label from a candidate set without requiring task-specific retraining. Candidate labels may be predefined or dynamically generated based on user input. The system compares the summary with each candidate label using semantic similarity metrics or embedding-based comparison, assigning scores to indicate confidence or likelihood.

Outputs—including, but not limited to, the generated summaries, selected attribute labels, confidence scores, and associated metadata—are organized into structured records. These records may be stored in a relational database, serialized in a JSON format, or fed into business automation platforms, enabling immediate use in quality assurance workflows, customer support triggers, or analytics dashboards.

In some embodiments, parts of the summarization and classification pipeline may execute in a distributed or cloud-hosted environment to support real-time processing and scalability across enterprise deployments.

By combining modular summarization with zero-shot classification and structured result generation, the present disclosure addresses the core challenges of accuracy, adaptability, and interpretability in automated conversation analysis systems.

These and other aspects of the invention will be described in further detail below with reference to the accompanying figures and examples.

### BRIEF DESCRIPTION OF THE FIGURES

FIG. 1 is a schematic representation of a variant of the method.

FIG. 2 is a schematic representation of a variant of S200.

FIG. 3 is a schematic representation of a variant of S300.

FIGS. 4A and 4B are schematic representations of specific examples of a variant of S200.

FIG. 5 is a schematic representation of a specific example of a variant of S300.

FIG. 6 is an illustrative example of a first variant of determining attribute values.

FIG. 7 is an illustrative example of a second variant of determining attribute values.

FIG. 8 is an illustrative example of a variant of the method.

FIG. 9 illustrates a simplified block diagram of a device with which aspects of the present disclosure may be practiced in accordance with aspects of the present disclosure.

### DETAILED DESCRIPTION

The following description of the embodiments of the invention is not intended to limit the invention to these embodiments, but rather to enable any person skilled in the art to make and use the present disclosure.

### Overview

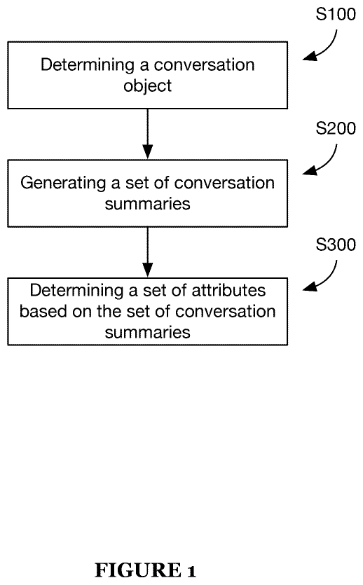

As shown in FIG. 1, variants of the method can include determining a conversation object S100, generating a set of conversation summaries S200, and/or determining a set of attribute values based on the set of conversation summaries S300. The method functions to analyze individual data records for attributes of interest in a fast and scalable manner.

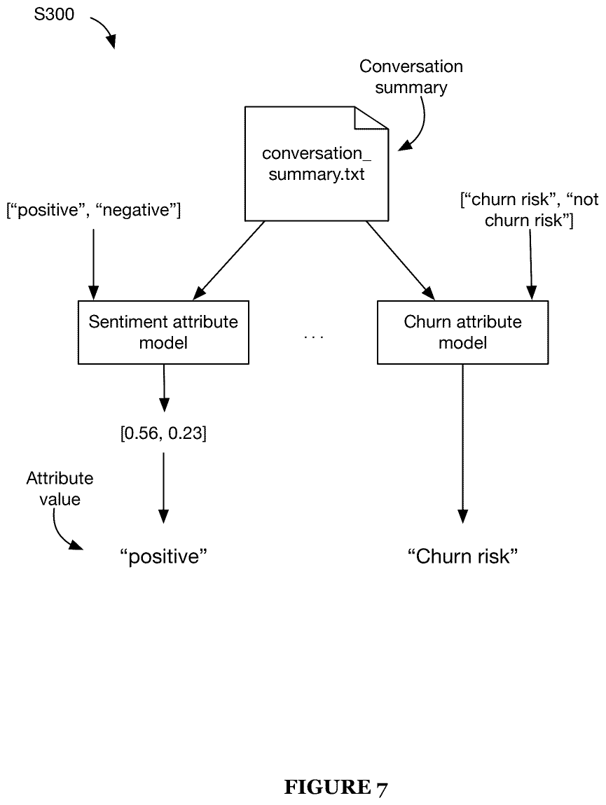

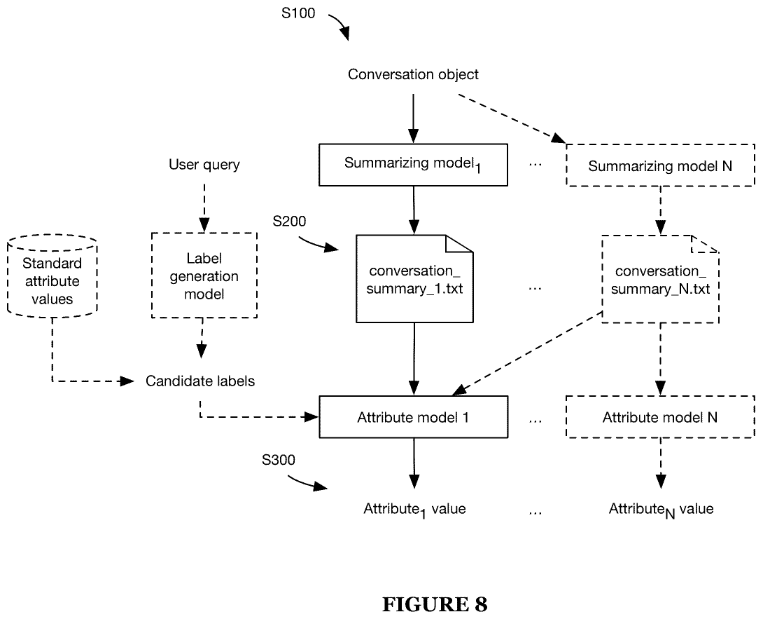

In an illustrative example (e.g., example shown in FIG. 8), the method for rapid natural language processing includes: determining a natural language object (e.g., a conversation recording, a transcript, etc.); generating a set of summaries for the natural language object, wherein each summary is structured and specific to, or includes information associated with, a specific natural language task (e.g., sentiment summary, topic summary, intent summary, resolution summary, etc.); and determining attribute values by providing one or more of the set of summaries to a set of attribute models trained to determine whether the one or more summaries exhibit the attribute. In a specific example, the attribute models can include zero-shot classifiers configured to classify a corpus (e.g., a summary associated with the attribute, the set of summaries, etc.) with a set of candidate labels (e.g., candidate attribute values; example shown in FIG. 7). Each zero-shot classifier can be specific to an analysis task, wherein the candidate labels can be specific to the task. For example, the sentiment zero-shot classifier can have [“positive”, “negative”] candidate labels, while a churn zero-shot classifier can have [“churn risk”, “no churn risk”] candidate labels. Alternatively, the candidate labels can be automatically determined from a user query about the natural language object (e.g., using a label generation model, such as a transformer model, foundation model, etc.).

However, the method can be otherwise performed.

### Technical Advantages

Variants of the technology can confer one or more advantages over conventional technologies.

First, the system enables analysis of a large corpus of long conversations (e.g., high token count) without needing to run a language model on each full conversation object. Using summaries instead of using full conversation objects can enable resource-efficient and faster analysis of conversations which would otherwise be resource-intensive to interpret using large language model. Further computational savings can be achieved by reusing the summaries in different workflows (e.g., model ensembles).

Second, in variants, system latency can be improved by using summaries, since the downstream models do not need to chunkify the raw natural language object, analyze each chunk, then stitch together the analyses after analysis. Instead, a single analysis can be run using the summary. In further variants, the summaries can preserve all the information needed for attribute analysis (e.g., using abstractive summarization, extractive summarization, etc.), which can preserve or increase the accuracy of the downstream models. For example, a set of summaries determined using the “escalation” attribute can include in-depth information for how and why different conversations were escalated to a manager instead of being resolved by a customer service associate and can include only “shallow” knowledge of the customer's demographics, sentiment, order history, and other information not related to escalation. Thus, an attribute model tasked with answering a question related to escalation (“Was the conversation escalated to a manager?”) can answer the question more easily.

Third, in variants, the system can generate accurate analyses on previously unseen data or data outside of the training distribution. This can drastically speed up deployment and development, especially in low-data regimes. In examples, this can be accomplished using zero-shot classifiers. In variants, using zero-shot classifiers can also improve the latency of the overall system because the models are relatively small and can be run in parallel (e.g., off the same set of summaries) to produce accurate analyses (e.g., attribute values) from a plurality of attributes. In variants, the latency can be further improved by limiting the set of candidate labels to 2 (e.g., a treating the classifiers as binary classifiers).

Fourth, retaining information about conversations in an abridged, human-readable form (e.g., summaries) enables users to quickly understand conversations with particular attributes without reading a long file. Additionally, human-readable summaries can help surface issues during training and inference. Additionally, human-readable summaries can enable using off-the-shelf LLMs to perform other tasks, including, but not limited to, data synthesis and model validation.

However, these examples are non-limiting, and further advantages can be provided by the system and method disclosed herein.

### System

The system functions to analyze a natural language object (e.g., conversation) to determine whether the natural language object exhibits a set of attributes.

The natural language object can be a conversation, a document, a transcript, and/or any other suitable natural language data. In an example, the natural language object can be a conversation object representing a conversation between a set of participants. However, any other natural language object can be used

Participants can be participants in the conversation. In variants, participants can be people, automatic systems (e.g., bots, conversational agents, large language models, etc.), groups (e.g., institutions, groups of customer service agents, teams, etc.), and/or any other suitable type of participant.

Conversation objects function to represent a conversation as data. Conversation objects preferably include unstructured data but can additionally or alternatively include structured data. Conversation objects preferably include data relating to all participants, but can alternatively include data related to a subset of participants. Conversation objects can optionally include labels for participants (e.g., identifying portions of the conversation object as corresponding to a particular participant, etc.). Conversation objects can be an audio file, video file, transcript, email chain, text chain, survey response, and/or any other suitable type of format. Conversation objects can optionally be preprocessed. In variants, preprocessing can include segmenting a conversation object (e.g., removing chunks of a conversation object based on relevance and/or another suitable factor), removing personally-identifiable information, removing filler words, identifying speakers, and/or any other suitable type of preprocessing. Conversation objects can be an original (e.g., raw) form but can alternatively be converted into a text transcript, JSON file, encoding, embedding, feature vector, and/or any other suitable type of form. However, conversation objects can be otherwise defined.

The system can be used with a set of attributes. Examples of attributes that can be used with the system include: sentiment, intent, domain-specific (e.g., churn, supply chain, product, cancellation, etc.), and/or other attributes. The system can generate one or more conversation summaries associated with a given attribute. The system can include one or more attribute models for each attribute. Each attribute can be associated with a set of attribute values. For example, the “sentiment” attribute can be associated with a “positive” and “negative” value; a “churn” attribute can be associated with “churn risk” and “no churn risk” values; a “product” attribute can be associated with “positive”, “negative”, and “damaged” values; and a “supply chain” attribute can be associated with “delayed”, “on time”, and “never received” values. The attribute values (e.g., values corresponding to attributes) can be manually determined, automatically-determined (e.g., by the attribute model) learned from historical natural language objects, and/or otherwise determined. The attribute values can be numbers, binary values, labels (e.g., classes), and/or have any other format.

The conversation summary functions to store information about the conversation. The conversation summary preferably highlights information for one or more attributes of the conversation, but can alternatively highlight generic information about the conversation and/or any other suitable type of information. The conversation summary can include human-readable text but can alternatively include an embedding and/or encoding representing the conversation, and/or data of any other suitable format. The conversation summary can be structured or unstructured. The conversation summary can be for a temporal part of a conversation, a subset of participants in the conversation, and/or any other suitable subset of the conversation. The conversation summary can summarize information from one conversation (e.g., one conversation object) or multiple conversations (e.g., serial conversations with a shared participant, conversations about similar attributes, etc.). However, the conversation summary can be otherwise defined.

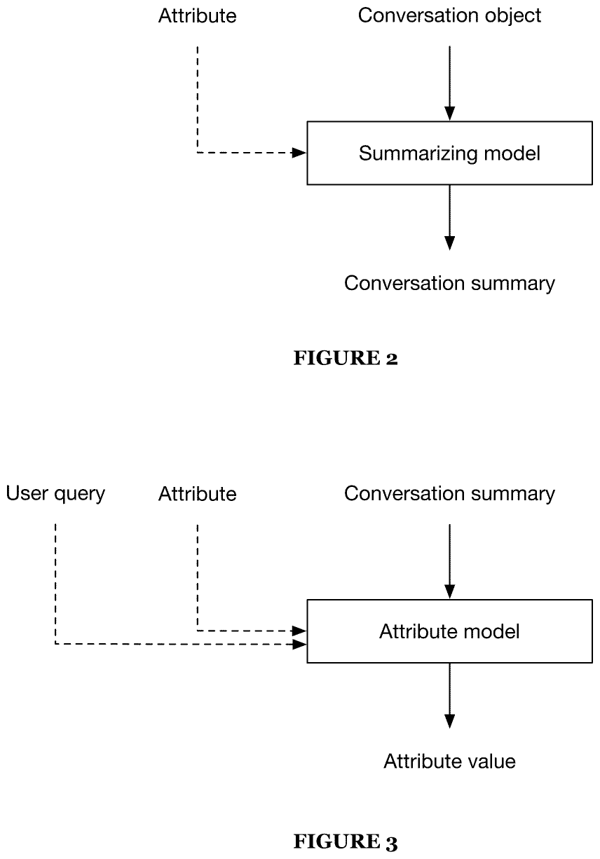

The summarizing model functions to generate a summarized conversation (e.g., example shown in FIG. 2). The system can include a single summarizing model (e.g., wherein different prompts are used to generate different summaries for different attributes); a different summarizing model for each attribute; and/or any number of summarizing models. The summarizing model is preferably a fine-tuned language model but can alternatively be any other suitable type of model. The summarizing model can be fine-tuned based on an attribute but can alternatively be fine-tuned based on other factors or not fine-tuned. The summarizing model preferably ingests conversation objects (or chunks thereof) as input, but can optionally additionally ingest other suitable inputs. Additional inputs to the summarizing model can include the attribute, other conversation summaries generated for the conversation, attribute values determined for the conversation (e.g., during a prior iteration of the method), participant-specific information (e.g., terminology, etc.), and/or any other suitable input. The summarizing model preferably outputs a conversation summary, and can additionally output conversation metadata, conversation attribute, conversation attribute values, and/or any other suitable information. The summarizing model can be trained on prior conversations and summaries, synthetic conversations and summaries, be untrained, and/or be otherwise trained. However, the summarizing model can be otherwise configured.

The attribute model functions to determine the set of attribute values (e.g., example shown in FIG. 3). The system can include one or more attribute models. In a first variant, the system includes one or more distinct attribute models for a given attribute. In a second variant, the system includes a single attribute model for all attributes. However, the system can include any number of attribute models. The attribute model is preferably a zero-shot classifier (e.g., a pretrained language model that has not seen examples of the class labels during training), but can additionally or alternatively be a single-shot classifier, few-shot classifier, a classifier trained using a large data corpus, a transformer model (e.g., BERT, Q&A models), a RAG model (e.g., with a retriever and generator), and/or another model. The attribute model is preferably a binary classifier but can alternatively be any other suitable type of model. The attribute model is preferably a smaller model (e.g., cheaper, faster, fewer layers, fewer parameters, smaller memory footprint, fewer computational resources needed, etc.) than the summarizing model but can alternatively not be a smaller model than the summarizing model. The attribute model input can be a conversation summary and optionally other predetermined attributes, another conversation summary, conversation metadata, candidate labels, a prompt, a user query, an attribute and/or other suitable inputs.

The attribute model can be pretrained, untuned, tuned, primed, unprimed, and/or otherwise trained. The training data can include summary-attribute value pairs, natural language object-attribute value pairs, and/or other data. The training data can be determined manually, automatically, synthesized (e.g., instructing an LLM to generate a conversation with a given attribute value), and/or otherwise determined.

In a first example, the attribute model inputs can include a conversation summary and a set of candidate labels, wherein the attribute model determines weights for each of the candidate labels (e.g., attribute values; etc.) based on the conversation summary. The set of candidate labels can be: predetermined for the attribute associated with the attribute model; determined from a user prompt (e.g., wherein a label model generates positive and negative labels that would answer a user prompt); and/or otherwise determined. In this example, the attribute model inputs can optionally include a prompt describing the task to the classifier (e.g., “determine weights for the candidate labels based on the summary”).

In a second example, the attribute model inputs can include a conversation summary and a prompt (e.g., a user query). For example, a BERT model with a question answering layer can answer user prompts against the conversation summary. In another example, a RAG model can answer user prompts against the conversation summaries. However, the attribute model can be otherwise configured.

However, the attribute model can be otherwise determined.

The models used herein can include classical or traditional approaches, machine learning approaches, and/or be otherwise configured. The models can include regression (e.g., linear regression, non-linear regression, logistic regression, etc.), decision tree, LSA, clustering, association rules, dimensionality reduction (e.g., PCA, t-SNE, LDA, etc.), neural networks (e.g., CNN, DNN, CAN, LSTM, RNN, encoders, decoders, deep learning models, transformers, etc.), ensemble methods, optimization methods, classification, rules, heuristics, equations (e.g., weighted equations, etc.), selection (e.g., from a library), regularization methods (e.g., ridge regression), Bayesian methods (e.g., Naive Bayes, Markov), instance-based methods (e.g., nearest neighbor), kernel methods, support vectors (e.g., SVM, SVC, etc.), statistical methods (e.g., probability), comparison methods (e.g., matching, distance metrics, thresholds, etc.), deterministics, genetic programs, and/or any other suitable model. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of self-attention layers; and/or have any other suitable architecture. The models can extract data features (e.g., feature values, feature vectors, etc.) from the input data, and determine the output based on the extracted features. However, the models can otherwise determine the output based on the input data.

Any model can optionally be run or updated: once; at a predetermined frequency; every time the method is performed; every time an unanticipated measurement value is received; or at any other suitable frequency. Any model can optionally be run or updated: in response to determination of an actual result differing from an expected result; or at any other suitable frequency. Any model can optionally be run or updated concurrently with one or more other models, serially, at varying frequencies, or at any other suitable time.

However, system components can otherwise be defined.

### Method

The method can include determining a conversation object S100, determining a set of conversation summaries S200, and/or determining a set of attribute values based on the set of conversation summaries S300. All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed.

Determining a conversation object S100 can function to record information about a conversation. S100 can be performed in real-time with the conversation and/or after the conversation is over. S100 can include receiving a conversation object from another entity and/or generating a conversation object. S100 can include further processing of the conversation (e.g., generating a transcript, translating the conversation, tagging participants, removing filler words and/or personally-identifiable information, etc.). S100 can include generating metadata about the conversation (e.g., a manual tag of the conversation, a participant-generated summary, etc.). S100 can be repeated for different conversations. In a specific example, S100 can include generating a transcript of an audio conversation between a chatbot and a customer, tagging text within the transcript with the identity of the associated participant, further processing the conversation, and outputting a file containing a cleaned-up transcript (e.g., a conversation object). However, determining a conversation object S100 can be otherwise performed.

Generating a set of conversation summaries S200 functions to consolidate key information about a conversation into a file which is smaller and/or more easily parseable than the conversation object. Conversation summaries enable the system to gather information related to an attribute into a single summary so that attribute values related to that attribute are easier for a simple model (e.g., the attribute model) to extract. S200 is preferably performed by the summarizing model but can alternatively be performed by any other suitable system component. Conversation summaries can be specific to an attribute, include information for multiple attributes, be independent of an attribute, and/or otherwise relate to the attributes. The summaries are preferably for the entire natural language object (e.g., entire conversation), but can alternatively be for: a segment of the conversation, different time segments of a conversation, and/or any other suitable portion of a conversation. In a first embodiment, S200 is performed using a summary model trained to extract summaries specific to the attribute. In a second embodiment, S200 is performed using a generic model (e.g., LLM) using a prompt specific to the attribute. The prompt can specify: the structure of the summary (e.g., what each sentence should include; the length of the summary; the tone of the summary; etc.), the content of the summary (e.g., what topics should be included or left out); whether extractive summarization (e.g., including, but not limited to, key sentences or phrases) or abstractive summarization should be used; and/or include other instructions.

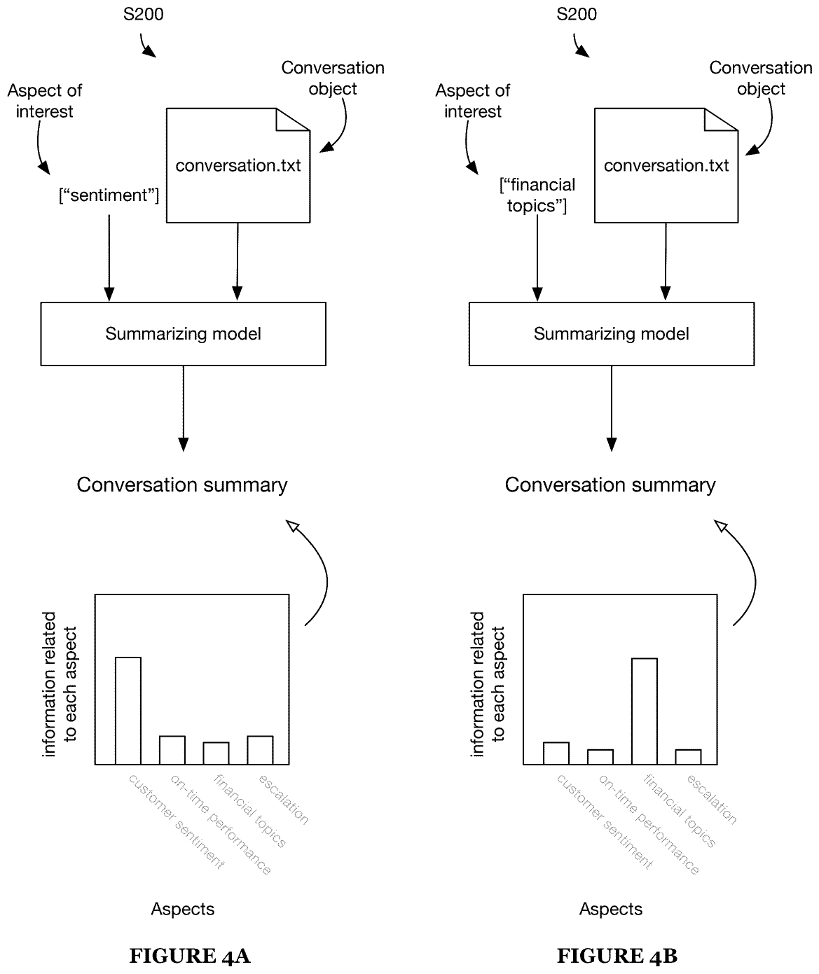

In a first variant, a conversation summary is generated for a single particular attribute. In this variant, the conversation summary can include all information in the conversation related to the attribute (e.g., examples shown in FIG. 4A and FIG. 4B). In an example, where the attribute is “refund” the summary can include the customer's issue with a product, whether the customer has had a prior conversation about the issue, a set of refund alternatives presented to the customer, the value of the refund, customer sentiment with respect to the refund, and/or other refund related and/or contextual information.

In a second variant, conversation summaries can be generated without using a particular attribute. In this variant, a conversation summary is a generic summary of the conversation. However, the summarizing model can otherwise use attributes.

Generating the conversation summary can be performed for multiple different conversations at once (e.g., when analysis is performed on a corpus of stored conversations), as conversations occur over time (e.g., each time a conversation is added to the corpus of stored conversations), and/or at any other suitable time. S200 can be performed for multiple attributes contemporaneously, concurrently, serially, or in any other temporal order. The conversation object can be retained or deleted after determination of the conversation summary. However, generating a set of conversation summaries can otherwise be performed.

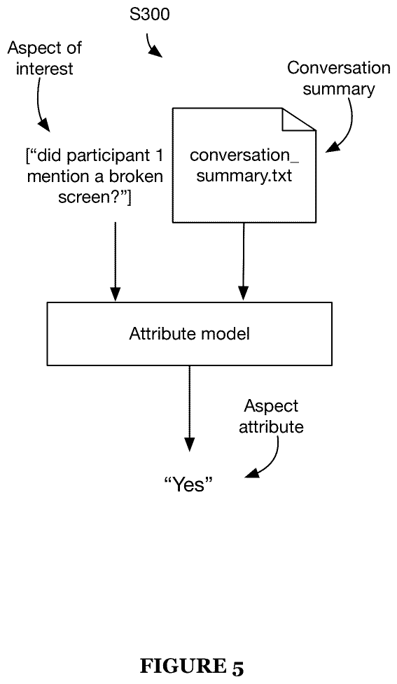

Determining a set of attribute values based on the set of conversation summaries S300 functions to determine particular attribute values of the conversation (e.g., example shown in FIG. 5). The resultant attribute values can be associated with the conversation, displayed to a user, analyzed with the attribute values extracted from other conversations (e.g., using the method) to identify population-level trends and insights, used to trigger mitigation actions (e.g., changing the supply chain, pausing manufacturing, controlling autonomous delivery vehicles, changing marketing campaigns, etc.), and/or otherwise used.

S300 is preferably performed on conversation summaries but can additionally or alternatively be performed on conversations, conversation metadata, predetermined attributes, and/or any other suitable information related to a conversation. Determining a set of attribute values can be performed by an attribute model and/or any other suitable system component.

S300 can be performed using one conversation summary or multiple conversation summaries. The multiple conversation summaries can be for multiple conversations, multiple parts of a conversation, and/or the same conversation (e.g., example shown in FIG. 8). The multiple summaries are preferably associated with the attribute being analyzed, but can alternatively be unrelated. For example, the sentiment summary can be provided alongside the churn summary to the churn attribute model. The multiple summaries can be concatenated, appended, summarized (e.g., by another summarization model), and/or otherwise managed.

Determining a set of attribute values can be performed responsive to a user request (e.g., wherein the user solicits attribute values for a user-input attribute), can be determined automatically (e.g., when the conversation object is generated), and/or can be performed responsive to any other suitable event. In a variant, determining a set of attribute values can optionally include determining which summary or set of summaries for a conversation to use as an input. In this variant, the summary can be user-selected, can be the summary which was generated using the attribute being used to generate the attribute value (e.g., the present attribute), can be the summary which was generated using an attribute similar to the present attribute, and/or can be otherwise selected.

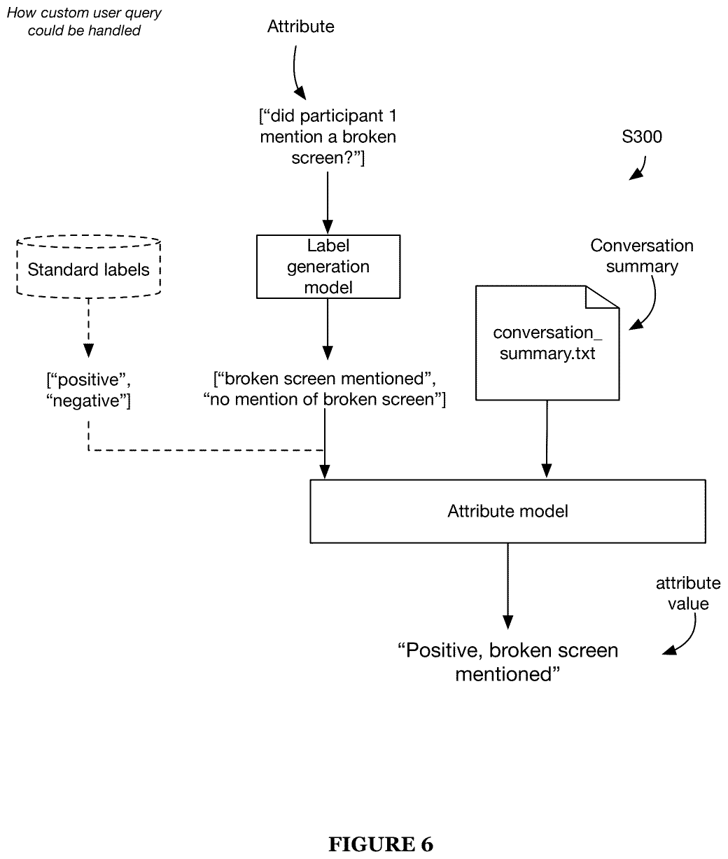

In a first variant, S300 includes: retrieving a set of attribute-specific labels; and providing the summary and the set of attribute-specific labels to the attribute model (e.g., a zero-shot classifier); wherein the attribute model classifies the summary using the set of attribute-specific labels (e.g., determines weights for each label; example shown in FIG. 6).

In a second variant, S300 includes: receiving a user query; generating a set of labels from the user query, wherein the set of labels include positive and negative outcomes; optionally selecting a summary (e.g., a summary associated with an attribute most related or similar to the user prompt); and optionally selecting an attribute model from the set of attribute models (e.g., the attribute model most related or similar to the user query); wherein the attribute model classifies the summary based on the set of labels. In this variant, the user query can be freeform (e.g., be any query), be constrained (e.g., to be a binary question), and/or be otherwise structured. In an illustrative example, the user query can include “is this representative of a negative customer?”, the labels can be [“representative of negative customer”, “not representative of negative customer”], a sentiment summary and sentiment model can be selected, and the sentiment model can determine whether the summary indicates that the customer is representative or not representative of a negative customer.

In a third variant, S300 includes: receiving a user query; embedding the user query into a latent space using an encoder; and comparing the embedding against the summary (e.g., wherein the summary is an embedding in the latent space) to determine whether the user query appears within the summary.

In a fourth variant, S300 includes using BERT to answer questions about the summary.

However, S300 can be otherwise performed.

However, determining a set of attribute values S300 can be otherwise performed.

However the method can be otherwise performed.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including, but not limited to, one or more collocated or distributed, remote or local processors) connected to the non-transitory computer-readable medium, such as CPU, GPUs, TPUS, microprocessors, or ASICs, but the instructions can alternatively or additionally be executed by any suitable dedicated hardware device.

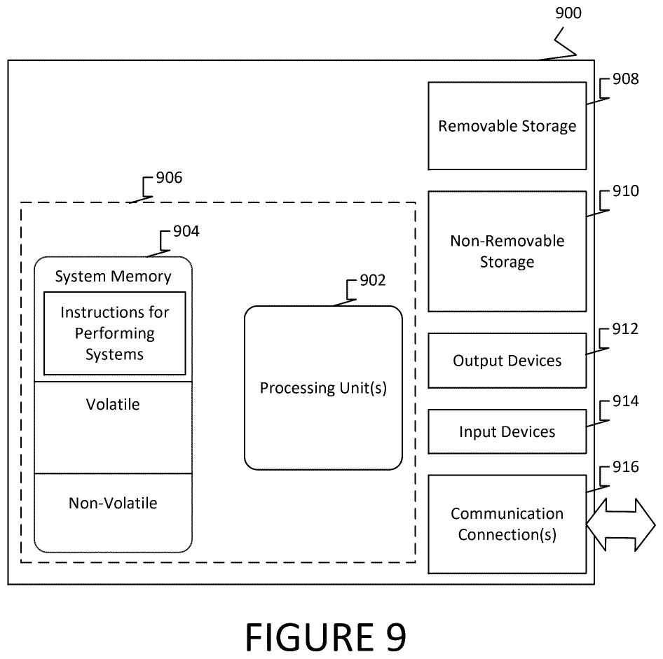

FIG. 9 and the associated descriptions provide a discussion of a variety of operating environments in which aspects of the disclosure may be practiced. However, the devices and systems illustrated and discussed with respect to FIG. 9 are for purposes of example and illustration and are not limiting of a vast number of computing device configurations that may be utilized for practicing aspects of the disclosure, described herein.

FIG. 9 illustrates a simplified block diagram of a device with which aspects of the present disclosure may be practiced in accordance with aspects of the present disclosure. The device may be a mobile computing device, for example. One or more of the present embodiments may be implemented in an operating environment 900. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 900 typically includes at least one processing unit 902 and memory 904. Depending on the exact configuration and type of computing device, memory 904 (e.g., instructions for generating a biometric hash as disclosed herein, etc.) may be volatile (such as RAM), non-volatile (such as ROM, flash memory, etc.), or some combination of the two. This most basic configuration is illustrated in FIG. 9 by dashed line 906. Further, the operating environment 900 may also include storage devices (removable, 908, and/or non-removable, 910) including, but not limited to, magnetic or optical disks or tape. Similarly, the operating environment 900 may also have input device(s) 914 such as remote controller, keyboard, mouse, pen, voice input, on-board sensors, etc. and/or output device(s) 912 such as a display, speakers, printer, motors, etc. Also included in the environment may be one or more communication connections 916, such as LAN, WAN, a near-field communications network, a cellular broadband network, point to point, etc.

Operating environment 900 typically includes at least some form of computer readable media. Computer readable media can be any available media that can be accessed by the at least one processing unit 902 or other devices comprising the operating environment. By way of example, and not limitation, computer readable media may comprise computer storage media and communication media. Computer storage media includes volatile and nonvolatile, removable and non-removable non-transitory media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 900 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

### Practical Examples and Implementation Considerations

The following section provides representative implementation scenarios, design considerations, and attribute-handling behaviors in support of the present disclosure. These examples are illustrative and not intended to limit the scope of the invention as claimed. The described components may be implemented individually or in combination with one another and may be adapted or extended for particular deployment environments or organizational use cases.

### Conversation Object Intake and Preprocessing

In certain embodiments, the computing system receives a conversation object comprising natural language data exchanged between at least two participants during a dialog session. The conversation object may originate from an audio stream, a live chat transcript, or an email thread. When the conversation object includes audio, the computing system may apply automatic speech recognition to produce a text-based transcript. In some cases, speaker diarization is applied to label each turn with the associated participant.

The conversation object may undergo preprocessing prior to summarization. Preprocessing may include normalizing text casing and punctuation, identifying participant turn boundaries, removing non-substantive filler words (e.g., “uh,” “you know”), and redacting personally identifiable information. These actions help reduce linguistic noise and preserve task-relevant content.

In other embodiments, the conversation object may originate from structured or semi-structured logs associated with customer service platforms. For example, customer support interactions over multiple channels (e.g., webchat, email, phone) may be consolidated into a normalized data format for unified analysis.

### Prompt-Guided Summarization by Analysis Task

The computing system may execute a summarization model to generate a plurality of conversation summaries from the conversation object. Each summary may correspond to a distinct natural language analysis task, such as sentiment classification, escalation detection, topic identification, or customer intent analysis.

In one embodiment, the summarization model is prompted with a natural language instruction that specifies the structure and scope of the desired output. For example, a summarization prompt may include the following instruction: “Summarize any points in this conversation where the customer asked to speak with a manager or where the agent transferred the case.”

Alternatively, for sentiment analysis, the prompt may read: “Summarize the customer's emotional tone throughout the interaction in three concise sentences.”

These prompts serve to condition the summarization model to isolate and extract semantically relevant content based on the specified analysis task. The summarization model may comprise a fine-tuned large language model configured for abstractive or hybrid summarization. The output is preferably a human-readable, task-specific summary that preserves relevant content from the original interaction while compressing irrelevant detail.

In some variants, the summarization model may be selected or configured dynamically based on the analysis task. In other embodiments, a single summarization model may handle multiple tasks by varying the prompt structure.

(See FIGS. 2, 4A, and 4B for examples of summary generation conditioned on task.)

### Attribute Evaluation Via Zero-Shot Classification

After the set of task-specific conversation summaries is generated, the system selects, for each attribute in a predefined set of attributes, one or more summaries relevant to that attribute. Each selected summary is input into an attribute model configured to determine whether the summary supports one or more values for the attribute.

The attribute model may include a zero-shot classifier trained to compare the content of the selected summary against a set of candidate labels associated with the attribute. In some embodiments, the candidate labels are predefined. In other embodiments, the candidate labels are generated dynamically in response to a user query. For example, a user may submit the query: “Is the customer showing signs of switching providers?”

In response, a label generation model may return candidate labels such as:
“Customer expressed intent to leave”
“Customer uncertain”
“Customer reaffirmed loyalty”

The attribute model embeds the summary and each candidate label into a shared semantic space and computes a similarity score for each pair. These similarity scores may be normalized to form a probability distribution over the label set. The label with the highest score may be selected as the classification output, optionally subject to a confidence threshold.

In some cases, the attribute model returns multiple labels with associated confidence scores. For example, the model may return:
“likely churn”: 82%
“unclear”: 13%
“unlikely churn”: 5%

The output may be thresholded or passed through a softmax layer to select a single most probable label.

(See FIGS. 6-8 for illustrative classification flows and label sampling.)

### Structured Output and Result Storage

The system may produce structured output data including, but not limited to:
Binary labels (e.g., “escalation occurred”: yes/no)
Multi-class labels (e.g., “topic”: billing, refund, account access)
Probabilistic outputs (e.g., “satisfaction”: 72% positive)
Human-readable summaries per task

These results are optionally stored in structured records linked to the original conversation object. Each record may include metadata fields such as:
conversation ID
timestamp
summaries per analysis task
attribute values per model
classifier confidence scores

For example, the resulting record may be structured as:

```
json
  {
    “conversation_id”: “abc123”,
    “summary_sentiment”: “Customer expressed increasing frustration
  with hold times and lack of resolution.”,
    “summary_escalation”: “Customer requested a manager after agent
  was unable to authorize refund.”,
    “attribute_values”: {
    “churn”: “likely”,
    “satisfaction”: “negative”
    },
    “confidence_scores”: {
    “churn_likely”: 0.82,
    “satisfaction_negative”: 0.91
    }
  }
```

These structured outputs may be stored in a vector database, relational table, or document store, and indexed to support retrieval and analysis.

### Action Triggering and System Automation

The structured attribute values may be used to initiate downstream automated actions. The system may include or interface with rule engines, workflow orchestration systems, or customer relationship management (CRM) platforms to respond to specific attribute classifications.

For instance:
If the escalation summary indicates that a manager was involved and the sentiment summary is negative, the system may route the conversation for human quality assurance review.
If the refund-related summary indicates a product defect and the attribute model classifies the resolution as unsatisfactory, the system may automatically initiate a refund or replacement workflow.
If the churn attribute is labeled “likely” and product satisfaction is labeled “negative,” the system may flag the conversation for retention outreach, assign a case priority score, or generate a targeted discount offer.

In certain embodiments, the system stores audit logs of these actions, enabling compliance tracking and feedback-loop training for continuous model improvement.

(See the Technical Advantages section and FIGS. 1 and 8 for illustrative system automation.)

### Distributed Execution and Hybrid Deployment

In some configurations, the summarization model and attribute model may be hosted on cloud-based inference servers or distributed compute nodes. The computing device transmits the conversation object or derived summaries to a remote server and receives the corresponding summaries and attribute classifications as output.

This deployment model reduces compute and memory requirements on local devices and allows resource pooling for high-throughput environments. In some cases, low-latency or real-time inference may be supported for live chat or voice call interactions.

Hybrid implementations may include local preprocessing and partial summarization followed by remote attribute classification. This approach may balance performance, privacy, and infrastructure constraints across deployment environments.

(See FIG. 9 for an example of distributed and cloud-assisted processing.)

### Data Structures and Metadata Organization

The final output may be stored in structured data formats suitable for analytics, auditing, or downstream consumption. In one embodiment, the output is stored as a structured JSON object or equivalent document representation that includes:
“conversation_id”
“summary_sentiment”
“summary_escalation”
“attribute_values” (e.g., {“churn”: “likely”, “satisfaction”: “negative”})
“confidence_scores” (e.g., {“churn_likely”: 0.82, “satisfaction_negative”: 0.91})

In other implementations, the structured outputs may be written to a relational database or indexed into a queryable dashboard. These formats support semantic filtering, performance monitoring, and reporting pipelines.

### Semantic Querying and User Feedback

Optionally, the system may support ad hoc queries or user feedback mechanisms. For example, a user may submit a natural language query such as:

The system may embed this query into the same vector space used for zero-shot classification and compare it against stored summaries or attributes using similarity metrics. The system may return:
A Boolean answer
A best-matching label with confidence
A supporting explanation drawn from the summary content

User responses may be captured as corrective feedback and used to fine-tune either the summarization model, the attribute classifier, or both. The system may include mechanisms to score, weight, or prioritize user-provided corrections based on role (e.g., analyst, supervisor) or historical accuracy.

### Attribute—Summary—Action Mapping (Table 1)

The following table illustrates representative mappings between specific conversation attributes, the corresponding summaries used to evaluate those attributes, candidate labels considered by the attribute models, and the automated system actions triggered by the evaluated outputs. These examples are not limiting and may be extended or adjusted for particular business workflows.

TABLE 1
Downstream attributes of actions

| | Summary | Candidate | |
|---|---|---|---|
| Attribute | Source(s) | Labels | Downstream Action(s) |
| Sentiment | Sentiment | positive, | Flag for review if |
| | summary | neutral, | negative; trigger |
| | | negative | feedback form if positive |
| Escalation | Escalation | escalated, not | Notify supervisor if |
| | summary | escalated | escalated; log for quality |
| | | | audit |
| Churn Risk | Sentiment + | likely, unlikely, | Prioritize retention; |
| | topic + refund | unclear | trigger customer success |
| | summaries | | workflow |
| Resolution | Resolution | satisfactory, | Auto-close or reopen |
| Quality | summary | unsatisfactory | ticket |
| Product | Topic + refund | damaged, | Initiate replacement or |
| Issue | summaries | wrong item, | return |
| | | not delivered | |
| Intent to | Intent + refund | intent | Route to retention or |
| Cancel | summary | expressed, | apply cancellation |
| | | unclear, no | procedure |
| | | intent | |
| | | expressed | |
| Delivery | Supply chain + | on time, | Trigger logistics review |
| Status | topic summary | delayed, not | or customer notification |
| | | received | |
| Agent | Escalation + | positive, | Generate coaching alert |
| Performance | sentiment + | neutral, | or performance log |
| | resolution | needs coaching | |
| | summaries | | |

These mappings support elements directed to, but not limited to, summary selection logic, candidate label application, structured metadata output, and automated action triggering.

In some embodiments, the candidate labels may be customized by an administrator and periodically updated to align with evolving business needs. The downstream actions may be defined in rule-based policies or implemented using third-party workflow automation platforms.

### Conclusion of Practical Implementation Support

The foregoing implementations demonstrate how the disclosed system can analyze natural language conversations using prompt-conditioned summarization and attribute evaluation models. These examples are provided to illustrate, not limit, the scope of the present disclosure. Variants described herein may be substituted, combined, or extended as appropriate for the technical environment or functional requirements of a given deployment, provided such variants remain within the bounds of the claimed subject matter.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method for analyzing a natural language conversation, the method comprising:
receiving, by a computing system, a conversation object comprising natural language data exchanged between a first participant and a second participant during a multi-turn interaction;
generating, by a summarization model executed by the computing system, a plurality of conversation summaries based on the conversation object, wherein each conversation summary of the plurality of conversation summaries is associated with a distinct natural language analysis task selected from a group comprising sentiment analysis, escalation detection, topic classification, and intent recognition; and
for each attribute in a predefined set of attributes:
selecting, by the computing system, at least one conversation summary of the plurality of conversation summaries that is associated with the respective attribute; and
classifying, by an attribute model associated with the respective attribute, the selected conversation summary to determine an attribute value for the respective attribute,
wherein the attribute model comprises a zero-shot classifier configured to evaluate the selected conversation summary against a set of candidate labels that is specific to the respective attribute, and
wherein the zero-shot classifier is further configured to assign a weight to each candidate label of the set of candidate labels indicating a likelihood that the selected conversation summary corresponds to the candidate label.

2. The method of claim 1, wherein the conversation object comprises at least one of an audio recording, a chat transcript, a customer service ticket, or an email thread, and wherein the computing system is further configured to convert audio content into a text-based transcript for use by the summarization model.

3. The method of claim 1, further comprising preprocessing, by the computing system, the conversation object prior to generating the plurality of conversation summaries, wherein the preprocessing comprises identifying participant boundaries, removing filler words, and redacting personally identifiable information to generate a normalized text representation.

4. The method of claim 1, wherein generating each conversation summary of the plurality of conversation summaries comprises providing the conversation object and a task-specific prompt to the summarization model, wherein the task-specific prompt specifies a summary structure and an analysis objective corresponding to a respective natural language analysis task.

5. The method of claim 4, wherein the summarization model comprises a transformer-based language model that has been fine-tuned for abstractive summarization, and wherein the summarization model is configured to output a human-readable summary that compresses and reorganizes relevant content from the conversation object.

6. The method of claim 1, further comprising generating, by a label generation model, the set of candidate labels for the respective attribute, wherein the label generation model is configured to receive a natural language query and produce a set of candidate labels that semantically correspond to the query.

7. The method of claim 6, wherein the attribute model is further configured to classify the selected conversation summary based on the set of candidate labels generated by the label generation model, and to output a ranked list of classification results for the respective attribute.

8. The method of claim 1, wherein the attribute value determined for the respective attribute comprises one of a binary classification, a multi-class label, or a normalized probability distribution over the set of candidate labels.

9. The method of claim 1, further comprising transmitting, by the computing system, the attribute value for the respective attribute to an automation module configured to execute a predefined system response based on the attribute value.

10. The method of claim 9, wherein the predefined system response comprises at least one of initiating a refund, flagging the conversation object for managerial review, or routing the conversation object to a resolution workflow based on the attribute value.

11. A system for analyzing natural language conversations, the system comprising:
at least one processor; and
a non-transitory memory storing instructions that, when executed by the at least one processor, cause the system to:
receive a conversation object comprising natural language content exchanged between a plurality of participants during a communication session;
generate, using a summarization model, a plurality of conversation summaries, wherein each conversation summary of the plurality of conversation summaries corresponds to a distinct natural language analysis task and comprises content derived from the conversation object; and
for each attribute in a set of attributes:
select at least one conversation summary of the plurality of conversation summaries that is associated with the attribute; and
determine an attribute value for the attribute by providing the selected conversation summary to an attribute model comprising a zero-shot classifier,
wherein the zero-shot classifier is configured to compare the selected conversation summary to a set of candidate labels that is associated with the attribute and to output a likelihood value for each candidate label indicating whether the selected conversation summary corresponds to the candidate label.

12. The system of claim 11, wherein the summarization model comprises a large language model configured to receive a task-specific prompt for each natural language analysis task and to output a summary conforming to the prompt parameters.

13. The system of claim 11, wherein the attribute model is configured to receive a user query and the set of candidate labels as inputs and to determine a corresponding attribute value for the attribute using a semantic classification function.

14. The system of claim 11, wherein the conversation object is obtained from a communication platform and comprises at least one of a call transcript, video session log, live chat exchange, or multichannel interaction history.

15. The system of claim 11, wherein the system is further configured to store each determined attribute value in association with the conversation object in a structured database record, wherein the structured database record is searchable based on the determined attribute values.

16. A non-transitory computer-readable memory storing executable instructions that, when executed by the processor, cause the computing device to:
receive a conversation object comprising natural language data exchanged between a first participant and a second participant during an interaction;
generate, using a summarization model, a plurality of conversation summaries, wherein each conversation summary of the plurality of conversation summaries corresponds to a different analysis task;
identify, for each attribute in a predefined set of attributes, at least one conversation summary of the plurality of conversation summaries that corresponds to the attribute; and
determine an attribute value for each attribute by applying a corresponding attribute model to the identified conversation summary,
wherein the corresponding attribute model comprises a zero-shot classifier configured to assign a classification to the identified conversation summary based on a comparison with a set of candidate labels specific to the attribute.

17. The non-transitory computer-readable of claim 16, wherein the summarization model is further configured to produce a summary having a format specified by a prompt that defines a summary structure, length, and content scope corresponding to the respective analysis task.

18. The non-transitory computer-readable of claim 16, wherein the corresponding attribute model is configured to assign a confidence score to each candidate label in the set of candidate labels and to output a ranked list of the candidate labels based on the confidence scores.

19. The non-transitory computer-readable of claim 16, wherein the instructions further cause the processor to generate a data structure comprising the conversation object and an associated set of attribute values determined by the corresponding attribute models.

20. The non-transitory computer-readable of claim 16, wherein the instructions further cause the processor to transmit the conversation object to a remote computing environment for processing by the summarization model and the corresponding attribute models and to receive the plurality of conversation summaries and the set of attribute values as returned outputs.
